(19) United States
(12) Patent Application Publication
(10) Pub. No.: US 2025/0159461 A1
(43) Pub. Date: May 15, 2025

(54) METHOD AND APPARATUS FOR PROCESSING DUPLICATE CALL OF DUAL SIM USER EQUIPMENT

(71) Applicant: KT CORPORATION, Gyeonggi-do (KR)

(72) Inventors: Byung-Jin JEONG, Gyeonggi-do (KR); Eun-Dong LEE, Gyeonggi-do (KR); June-Young JEON, Gyeonggi-do (KR)

(73) Assignee: KT CORPORATION, Gyeonggi-do (KR)

(21) Appl. No.: 18/941,933

(22) Filed: Nov. 8, 2024

(30) Foreign Application Priority Data
Nov. 10, 2023 (KR) 10-2023-0155265

(51) Int. Cl. H04W 8/18; H04L 65/1069; H04W 4/16; H04W 4/60; H04W 76/10

(52) U.S. Cl. CPC H04W 8/18; H04L 65/1069; H04W 4/60; H04W 76/10; H04W 4/16

(57) ABSTRACT

Provided are a method and apparatus for processing duplicate calls. The method of a first receiving application server includes receiving an INVITE message from a sending UE, verifying whether a receiving UE is a dual SIM subscriber by querying subscriber information based on a recipient number in the INVITE message, when the receiving UE is determined as a dual-SIM subscriber, identifying the recipient number as a first number associated with a first SIM, withholding the INVITE message and sending a virtual INVITE message to a second receiving application server connected to a second SIM of the receiving UE; receiving, from the second receiving application server, a response message including a call status of the second SIM: and determining whether to establish a call connection between the first SIM and the sending UE, based on the call status of the second SIM included in the response message.

### BACKGROUND

The disclosure relates to a method and apparatus for processing duplicate call of a user equipment having dual subscriber identification modules (SIMs). In particular, the disclosure relates to a method and apparatus for proving a duplicate call processing service to subscribers.

A dual SIM phone is a device that allows the use of two phone numbers on a single device. The dual SIM phone includes two or more universal subscriber identity module (USIM) slots, where different carriers' USIMs can be installed and used. Recently, with the introduction of embedded SIM (eSIM) technology, dual SIM phones can use eSIMs in addition to physical USIM slots. Furthermore, in some cases, it is possible to use more than one eSIM.

In countries with vast territories where it is challenging for a single telecom provider to offer nationwide service, dual SIM phones have been widely used for a long time.

Currently, most dual SIM phones use the ‘Dual SIM Dual Standby (DSDS)’ mode, where only one line can be active at a time. This means that the two SIM cards cannot communicate simultaneously. In other words, if the phone has both SIM 1 (SIM #1) and SECOND SIM (SIM #2), and SIM 1 is in use for a call, SECOND SIM becomes inactive, causing any communication on the second SIM to be interrupted. Only after the call on SIM 1 ends does SECOND SIM become active again, allowing communication to resume.

Duplicate call refers to a situation where a call is made to SECOND SIM while SIM 1 is in use for a call. For example, if SIM 1 is engaged in a call and a call comes in on SECOND SIM, SECOND SIM is in an inactive state, so the call will not be received, and there will be no response. The caller will experience a situation where the call attempt is made, but no ringing tone is heard, and there is complete silence.

To explain with a specific example, duplicate calls can occur in an IP multimedia subsystem (IMS) network. In this case, a receiving application server sends an INVITE message to a receiving user equipment (UE) and waits for a response for a certain period. If there is no response, the receiving application server cannot determine whether the receiving UE is engaged in a call or not. Therefore, the receiving application server takes no action until the timer expires. As a result, instead of notifying the caller that the line is busy, the receiving application server gives a ‘no service area’ notification after the timer expires.

If the timer is set to a long duration (usually 15 to 38 seconds), the caller may give up before the timer ends. In this case, the caller does not receive any notification and may mistakenly think that the recipient has rejected the call. Additionally, the recipient has no way of knowing who attempted to call.

### SUMMARY

In accordance with an embodiment, a method of a first receiving application server may be provided for processing duplicate calls. The method may include receiving an INVITE message sent from a sending user equipment (UE) through a sending network, verifying whether a receiving UE is a dual subscriber identification module (SIM) subscriber by querying subscriber information based on a recipient number in the INVITE message, in an event that the receiving UE is determined as a dual-SIM subscriber, identifying the recipient number as a first number associated with a first SIM, withholding the INVITE message from being sent to the receiving UE, sending a virtual INVITE message to a second receiving application server connected to a second SIM of the receiving UE, receiving, from the second receiving application server, a response message including a call status of the second SIM, and determining whether to establish a call connection between the first SIM and the sending UE, based on the call status of the second SIM included in the response message.

The determining whether to establish may include, in an event that the call status of the second SIM is a busy status, transmitting a response message to the sending network including that the first SIM is in a busy status.

The method may further include providing a supplementary service based on subscription status of the first SIM, wherein the supplementary service includes a call waiting service that notifies incoming call, provide an option to answer or decline, and switches between calls, and a call notification service that notifies a missed call and provides sender information.

The determining whether to establish may include, in an event that the response message is a call connection error message with the second SIM, determining the call status of the second SIM as idle, forwarding the INVITE message received from the sending network to the first SIM, and proceeding with a call setup process between the sending UE and the first SIM.

The call connection error message may be caused by a codec mismatch error. The virtual INVITE message may include a session description protocol (SDP) field in a message body, configured with an unsupported codec, which is not supported by an associated call service.

The virtual INVITE message may include at least one header field configured not to inform sender's information.

The sending a virtual INVITE message to a second receiving application server may include, in an event that a dual number field in a subscriber query response from a first subscriber server contains a dual number, sending the virtual INVITE message.

The sending a virtual INVITE message to a second receiving application server may include sending the virtual INVITE message in an event that the call status of the first SIM is idle.

The virtual INVITE message includes an indicator that indicates the virtual INVITE message is a virtual message intended for verifying a call status of the dual number. In this case, the second receiving application server perform operations may include checking the call status of the dual number in an event that the indicator included in the virtual INVITE, not forwarding the virtual INVITE message to the second SIM associated with the dual number in an event that the status is determined as idle, and responding to the first receiving application server with an error message.

In accordance with another embodiment, a method of a first subscriber server may be provided for processing duplicate calls. The method may include receiving a subscriber query request from a first application server that receives an INVITE message from a sending user equipment (UE) to a first subscriber identification module (SIM) through a sending network, verifying whether a subscriber associated with a recipient number assigned to the first SIM, included in the subscriber query request, is a dual-SIM subscriber, and sending a subscriber query response, including the dual number assigned to a second SIM, to the first receiving application server to enable checking the call status of the second SIM.

The verifying may include determining whether the dual number is stored in a dual number field of a scriber profile, which is defined to store the dual number.

The verifying may include checking whether the dual number is stored in a second dual number field, where the second dual number field is allocated for a dual number subscriber of a second service provider which is different from a first service provider associated with the first SIM, after the verifying, in an event that the dual number is not stored in the second dual number field, checking whether the dual number subscriber is a subscriber of the first service provider associated with the first SIM, and in an event that the dual number subscriber is the subscriber of the first service provider, upon receiving a call status inquiry for the recipient number from the first receiving application server, checking the call status of the dual number if the call status of the recipient number is idle, sending a response message to the first receiving application indicating that the recipient number is busy if the call status of the dual number is confirmed as busy.

The method may further include, prior to the receiving a subscriber query request from a first application server, extracting the dual number from a dual number field of a REGISTER message received from a user equipment, and including the extracted dual number in the dual number field of the subscriber profile.

The method may further include, prior to the receiving a subscriber query request from a first application server, receiving a call setup request from the UE that includes a predetermined feature code, and recording the dual number extracted from the call setup request in the dual number field of the subscriber profile.

In accordance with further another embodiment, an application server may be provided for processing duplicate calls. The application server may include a memory configured to store at least one command, and a processor configured to execute the stored at least one commands. The processor may perform operations including: verifying whether a receiving UE is a dual subscriber identification module (SIM) subscriber by querying subscriber information based on a recipient's number in an INVITE message received from a sending UE through a sending network; in an event that the receiving UE is determined as a dual-SIM subscriber, identifying the recipient's number as a first number associated with a first SIM, withholding the INVITE message from being sent to the receiving UE, sending a virtual INVITE message to a second receiving application server connected to a second SIM of the receiving UE; receiving, from the second receiving application server, a response message including a call status of the second SIM: and determining whether to establish a call connection between the first SIM and the sending UE, based on the call status of the second SIM included in the response message.

The processor may perform, in an event that the call status of the second SIM is a busy status, transmitting a response message to the sending network including that the first SIM is in a busy status.

The processor may further perform providing a supplementary service based on subscription status of the first SIM, wherein the supplementary service includes a call waiting service that notifies incoming call, provide an option to answer or decline, and switches between calls, and a call notification service that notifies a missed call and provides sender information.

The processor may perform, in an event that the response message is a call connection error message with the second SIM, determining the call status of the second SIM as idle, forwarding the INVITE message received from the sending network to the first SIM, and proceeding with a call setup process between the sending UE and the first SIM.

The virtual INVITE message includes an indicator that indicates the virtual INVITE message is a virtual message intended for verifying a call status of the dual number. In this case, the second receiving application server perform checking the call status of the dual number in an event that the indicator included in the virtual INVITE, not forwarding the virtual INVITE message to the second SIM associated with the dual number in an event that the status is determined as idle, and responding to the first receiving application server with an error message.

### BRIEF DESCRIPTION OF THE DRAWINGS

FIG. 1 is a diagram illustrating a network structure for handling duplicate calls in a dual SIM UE (Subscriber Identification Module User Equipment) according to an embodiment.

FIG. 2 is a diagram that illustrates a network structure for handling duplicate calls in a dual SIM UE according to another embodiment.

FIG. 3 is a diagram illustrating a situation where a duplicate call issue occurs in a dual SIM UE.

FIG. 4 is a flowchart illustrating a method for handling duplicate calls in accordance with an embodiment.

FIG. 5 is a flowchart illustrating the SIP signaling procedure when the call status of the dual number on SECOND SIM of the sending UE is in an idle state, according to an embodiment.

FIG. 6 is a flowchart illustrating a method for handling duplicate calls when the dual number on the second SIM is in a busy state, according to an embodiment.

FIG. 7 is a flowchart illustrating a method of handing duplicate call when the call status of the destination number is in a busy state, according to one embodiment.

FIG. 8 is a diagram illustrating a virtual INVITE (vINVITE) message according to an embodiment.

FIG. 9 illustrates the registration procedure for dual SIM information on a dual SIM device.

FIG. 10 shows a method for registering a dual number of a dual SIM device according to another embodiment.

FIG. 11 shows the network structure for handling duplicate calls in a dual-SIM UE according to another embodiment.

FIG. 12 is a flowchart illustrating the SIP signaling procedure for a dual-SIM subscriber UE according to another embodiment.

FIG. 13 is a flowchart illustrating the SIP signaling procedure when the dual SIMs of the receiving UE are determined to be subscribed to the same telecommunications provider, according to one embodiment.

FIG. 14 is a block diagram illustrating the hardware configuration of a computing device according to one embodiment.

### DETAILED DESCRIPTION OF EMBODIMENTS

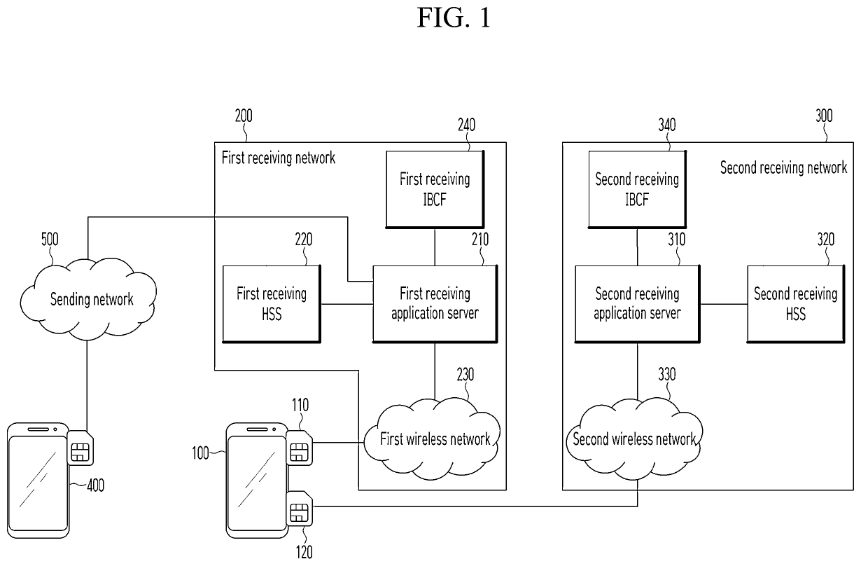

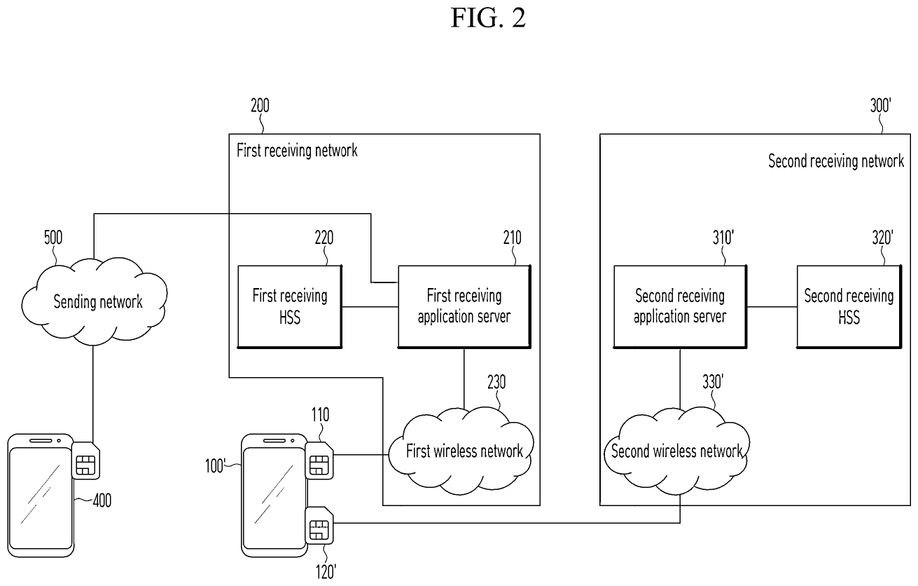

Hereinafter, a network structure for handling duplicate calls according to the embodiments will be described with reference to FIG. 1 and FIG. 2.

FIG. 1 is a diagram illustrating a network structure for handling duplicate calls in a dual SIM UE (Subscriber Identification Module User Equipment) according to an embodiment. FIG. 2 is a diagram that illustrates a network structure for handling duplicate calls in a dual SIM UE according to another embodiment.

Referring to FIG. 1 and FIG. 2, a receiving network and a sending network are communication networks and have the same configuration. However, for the convenience of explanation, the receiving and sending networks are distinguished in FIG. 1 and FIG. 2, and the embodiments will be described focusing on the structure of the sending network.

The sending network may be referred to as an originating network, a source network, a calling network, an outbound network, and an origin network. The receiving network may be referred to as a terminating network, a destination network, a call termination network, an inbound network, a receiving end network, and a termination point network.

A sending user equipment (UE) 100 is a dual SIM UE that includes two SIMs, 110 and 120. The two SIMs, 110 and 120, are connected to separate sending networks, 200 and 300, respectively. That is, a first SIM 110 is connected to the first sending network 200, and a second SIM 120 is connected to the second sending network 300. As described above, the receiving UE 100 may also be referred to as a receiving UE or a destination UE. Further, a UE may be a phone or any device used by the end user to communicate over a network. The UE may include a mobile phone, a smart phone, or any user equipment (UE) capable of sending and receiving communications, such as calls or data.

Referring to FIG. 1, the first sending network 200 and the second sending network 300 are communication networks operated by different service providers. The first sending network 200 includes a first receiving Telephony Application Server (TAS: 210), a first receiving Home Subscriber Server (HSS: 220), a first wireless network 230, and a first sending Interconnection Border Control Function (IBCF: 240). The second sending network 300 includes a second receiving Telephony Application Server 310, a second receiving HSS 320, a second wireless network 330, and a second sending IBCF 340.

The first SIM 110 is connected to the first call receiving application server 210 through the first wireless network 230. The second SIM 120 is connected to the second call receiving application server 310 through the second wireless network 330.

The first receiving Telephony Application Server (TAS: 210) and the second receiving Telephony Application Server (TAS: 310) may send and receive SIP messages through the interworking between the first sending IBCF 240 and the second sending IBCF 340.

The sending UE 400 is connected to the sending network 500 and may send an INVITE message for requesting a call.

Referring to FIG. 2, the first sending network 200 and the second sending network 300′ are communication networks of the same service provider. The network structure in FIG. 2 is almost identical to the structure in FIG. 1. However, since the first receiving Telephony Application Server (TAS: 210) and the second receiving Telephony Application Server (TAS: 310) belong to the same service provider, they are directly connected without the need for an Interconnection Border Control Function (IBCF).

These network structures shown in FIG. 1 and FIG. 2 may coexist. That is, the receiving UE 100 may include two SIMs, 110 and 120, from different service providers as shown in FIG. 1, or the receiving UE 100′ may include two SIMs, 110 and 120′, from the same service provider as shown in FIG. 2.

The Radio Access Network (RAN: 220, 330) includes base stations and base station controllers responsible for connecting UEs 100 and 400 through the wireless section. The RAN may transmit call request signals and the like from the sending UE 400 and the receiving UE 100 to the core network.

The Home Subscriber Server (HSS) 220, 320, 320′ serves as the master database for subscribers, and it can store and manage subscriber profiles, authentication data, and location-related information.

The Interconnection Border Control Function (IBCF) 240, 340 serves as a Border Controller when interworking between IMS networks, handling security and interconnection issues when interfacing with various networks. It supports network interworking between different service providers.

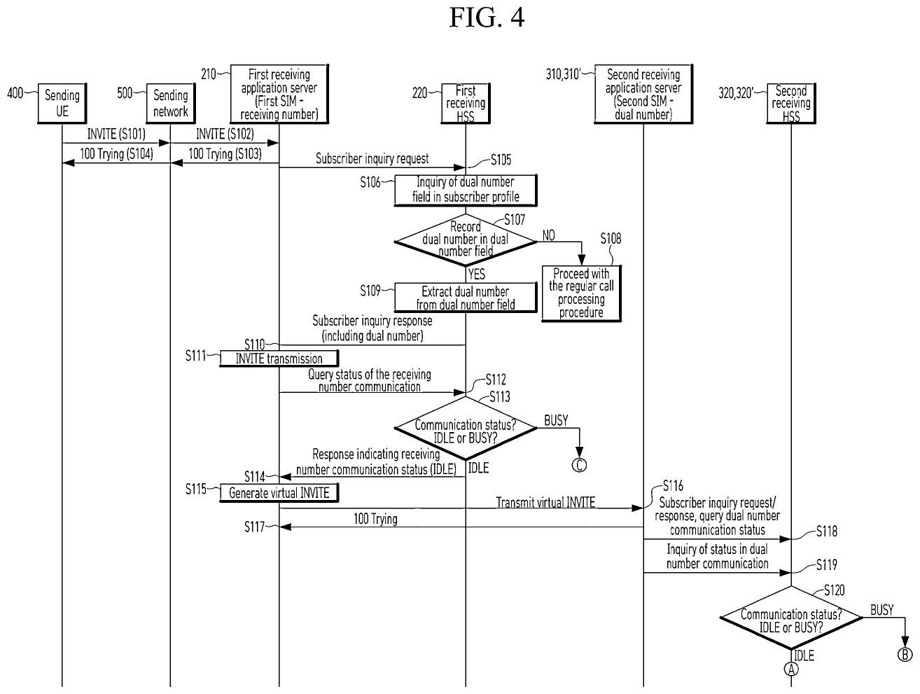

Since the components of the first sending network 200, the second sending networks 300, 300′, and the sending network 500 correspond to common components of an IP Multimedia Subsystem (IMS) network, detailed descriptions are omitted, and the operations related to the embodiments of the disclosure will be described later with reference to FIG. 4 to FIG. 6.

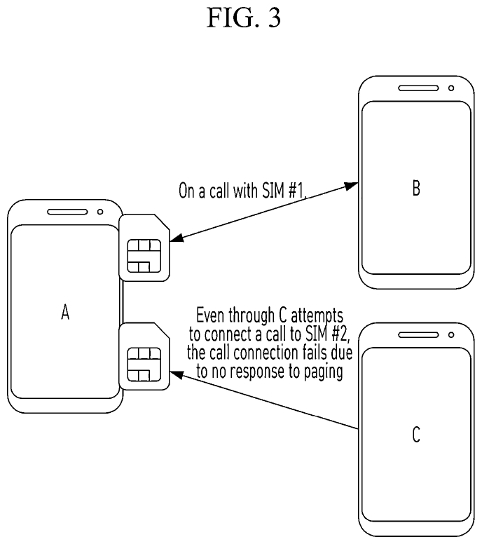

FIG. 3 is a diagram illustrating a situation where a duplicate call issue occurs in a dual SIM UE.

The duplicate call refers to a situation where a call is made to the second SIM while the first SIM is in use for a call. For example, if the first SIM is engaged in a call and a call comes in on the second SIM, the second SIM is in an inactive state, so the call will not be received, and there will be no response. The caller will experience a situation where the call attempt is made, but no ringing tone is heard, and there is complete silence.

A dual SIM UE is a mobile phone that uses two SIM cards, meaning it is equipped with a first SIM and a second SIM in a single phone. In this case, a duplicate call issue may occur. The duplicate call issue refers to a situation where a call comes in on SECOND SIM while SIM 1 is in use for a call.

FIG. 3 shows a situation where Dual SIM UE A is engaged in a call with UE B using SIM 1, while UE C places a call to SECOND SIM of Dual SIM UE A. In this case, since UE A is busy with a call on SIM 1, it cannot receive the incoming call from UE C on SECOND SIM. As a result, UE C does not hear any response and may feel as though UE A is in a no-service area.

At this time, Dual SIM UE A has SIM 1 active, but SECOND SIM is in an inactive state. Therefore, Dual SIM UE A cannot perform paging for the incoming call on SECOND SIM and cannot send a response to the IMS network. As a result, UE C, despite making the call, does not hear a ringing tone or any sound.

The sending application server in the IMS network does not inherently know whether UE A is a dual SIM device. Therefore, when the sending application server receives an INVITE message, it checks the call status of the sending subscriber from the subscriber profile. If the query returns a response indicating that the call status is idle, the server performs the usual sending operation of forwarding the INVITE message to UE A.

At this point, the sending application server generally sets and starts a no-service area timer simultaneously when sending the INVITE message to UE A. However, since the sending Dual SIM UE A is engaged in a call on the other SIM (dual number), it cannot send a response to the sending application server.

Therefore, since the sending application server does not receive a response from UE A within the duration of the no-service timer, it concludes that UE A is in a no-service area. Consequently, it sends a no-service area notification to the receiving UE, UE C.

In other words, because the IMS network has no way of determining whether Dual SIM UE A is engaged in a call when there is no response, it takes no action until the timer expires. As a result, even though Dual SIM UE A is actually busy with a call, UE C does not receive a busy tone but instead hears a no-service area notification after the timer expires.

Additionally, the no-service timer is generally set to a relatively long duration, for example, from 15 to up to 38 seconds. As a result, in many cases, UE C gives up on the call before the timer expires. In this situation, UE C does not hear any notification and may mistakenly think that the other party has rejected the call or believe that the issue is due to poor service quality from their current carrier. Furthermore, from the perspective of Dual SIM UE A, there is no way to know that UE C tried to call.”

To address these issues, the disclosure introduces a Session Initiation Protocol (SIP) signaling method to resolve the duplicate call problem in dual SIM UEs. Hereinafter, a method for handling duplicate calls in accordance with an embodiment will be described with reference to FIG. 4 to FIG. 7.

FIG. 4 is a flowchart illustrating a method for handling duplicate calls in accordance with an embodiment. In other words, the Session Initiation Protocol (SIP) signaling procedure for handing duplicate calls occurring when the sending UE is a dual SIM subscriber, according to an embodiment is shown in FIG. 4 to FIG. 7.

In FIG. 4, a receiving UE 100 is a dual SIM UE equipped with a first SIM 110 and a second SIM 120. The first SIM 110 is connected to the first receiving Telephony Application Server (TAS: 210), and the second SIM 120 is connected to the second receiving Telephony Application Server (TAS: 310). A sending UE 400 makes a call to a phone number assigned to the first SIM 110 of the receiving UE 100.

The embodiment will be described as a method for the case when the first SIM 110 and the second SIM 120 are associated with different telecommunications service providers. However, this is solely for the sake of clarity and convenience in description, and the embodiments are not limited to this scenario. For example, this embodiment may also be applied when the first SIM 110 and the second SIM 120 are associated with the same service provider.

Referring to FIG. 4, at step S101, the sending UE 400 sends an INVITE message to the sending network 500 when the sending UE 400 initiates a call using a phone number (e.g., recipient number) of the first SIM 110 of the receiving UE 100, which is a destination number. In the session initiation protocol (SIP), the INVITE message is used to initiate a session, such as a voice or video call, over an IP network. When a call is made using a VoIP service, the INVITE message is sent from the caller's device (the sender) to the recipient's device (the receiver) to request the establishment of a communication session.

At step S102, the sending network 500 receives the INVITE message and forwards the received INVITE message to the first receiving Telephony Application Server (TAS: 210).

At step S103, the first receiving Telephony Application Server (TAS: 210), which is connected to first SIM 110, responds to the sending network 500 with a 100Trying message. In SIP, the 100 Trying message is an informational response sent by the server to let the client know that the request has been received and is being processed.

At step S104, the sending network 500 sends the 100 Trying message to the sending UE 400.

At step S105, the first receiving Telephony Application Server (TAS: 210) sends a subscriber inquiry request to the first receiving Home Subscriber Server (HSS: 220) to query the registration information and supplementary service information of the sending network.

In this embodiment, a home subscriber server (HSS) is described as a server for handling subscriber information storage, authentication and authorization function, location management, and service control in an LTE network. However, the embodiment is not limited thereto. For example, HSS may be replaced with unified data repository (UDR) in a 5G network or any server that is capable of handling subscriber information storages, authentication and authorization, location management, and service control in a telecommunication network.

At step S106, the first receiving Home Subscriber Server (HSS: 220) queries the dual number field of the subscriber profile based on the destination number included in the subscriber inquiry request.

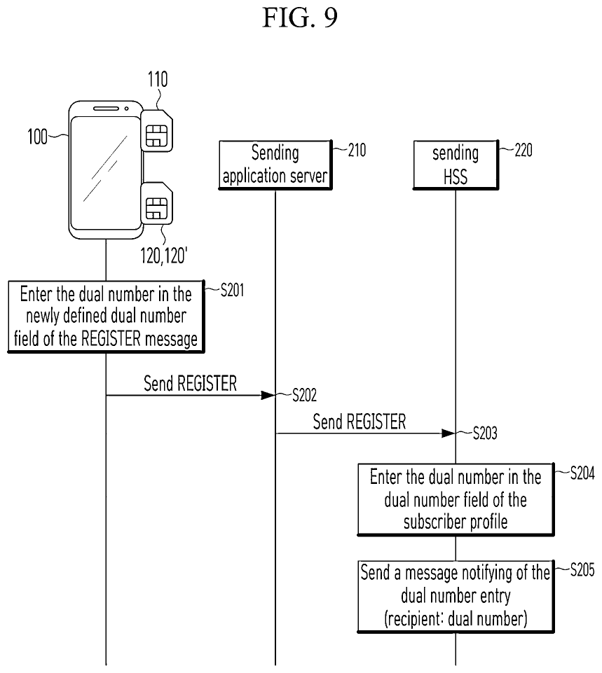

In accordance with an embodiment, a dual number field may be defined in the subscriber profile stored in HSS, and the dual number, which is the phone number of the second SIM, is recorded in the dual number field regardless of whether the service provider of the second SIM is the same as or different from the service provider of the first SIM during the subscriber information registration phase. Such registration phase will be described in later with reference to FIG. 9. If the second SIM is associated with a service provider different from that of the first SIM, the phone number of the second SIM is extracted from the network registration message and recorded in the dual number field. If the second SIM is associated with a service provider same as that of the first SIM, it is automatically registered in accordance with an embodiment.

At step S107, the first receiving Home Subscriber Server (HSS: 220) determines whether a dual number is recorded in the dual number field of the subscriber profile.

If no dual number is recorded in the dual number field (S107—NO), the first receiving Home Subscriber Server (HSS: 220) determines that the receiving UE 100 is not a dual number subscriber (e.g., not a dual SIM UE) and proceeds with the standard call handling procedure at step S108.

If a dual number is recorded in the dual number field (S107—YES), the first receiving Home Subscriber Server (HSS: 220) determines that the receiving UE 100 is a dual SIM UE and extracts the dual number from the dual number field of the subscriber profile.

At step S110, the first receiving Home Subscriber Server (HSS: 220) includes the extracted dual number in the subscriber inquiry response and sends it to the first receiving Telephony Application Server (TAS: 210). At this point, the subscriber inquiry response may be a 200 OK message.

According to an embodiment, the extracted dual number may be included in a newly defined dual number field in the 200 OK message.

In this embodiment, if the value of the dual number field exists in the subscriber inquiry response message (e.g., 200 OK message) received from the first receiving HSS 220, the first receiving Telephony Application Server (TAS: 210) may determine that the receiving UE 100 is a dual SIM UE and obtain the dual number of the subscriber, that is, the phone number of second SIM 120.

At step S111, if the first receiving Telephony Application Server (TAS: 210) confirms that the receiving UE 100 is a dual SIM subscriber, the first receiving TSA 210 may withhold sending out the INVITE message, which was received at step S102.

At step S112, the first receiving Telephony Application Server (TAS: 210) queries the first receiving HSS 220 for the call status of the recipient number, which is the phone number of first SIM 110.

At step S113, the first receiving Home Subscriber Server (HSS: 220) determines whether the call status of the destination number is in an idle state or a busy state.

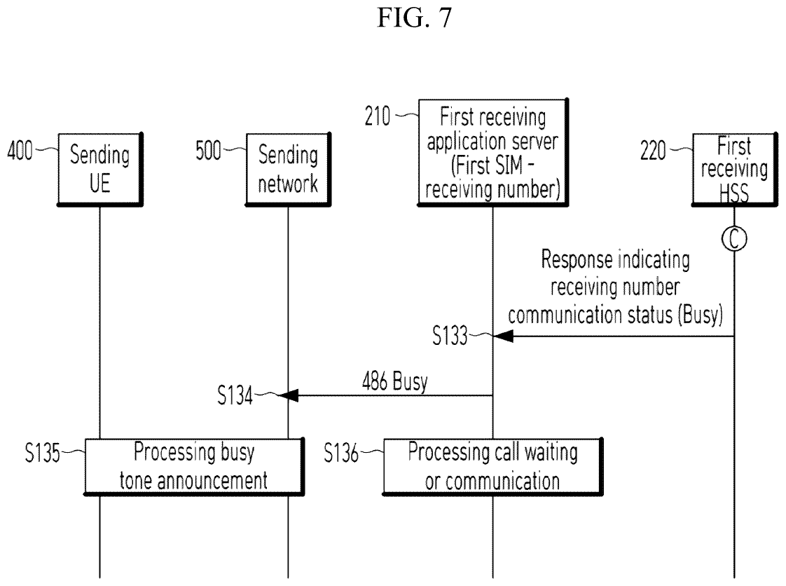

If the first receiving HSS 220 determines that the call status of the destination number is in a busy state, it performs busy call handling, that is, the procedure outlined in FIG. 7.

At step S114, if the first receiving HSS 220 determines that the call status of the destination number is in an idle state, the first receiving HSS 220 sends a call status response to the first receiving TAS 210, indicating that the call status of the destination number is idle.

At step S115, if the first receiving TAS 210 confirms that the call status of the destination number is idle, the first receiving TAS 210 does not immediately send out the INVITE message to the receiving UE 100 (e.g., withhold sending out the INVITE message), as in the typical IMS sending network operation. Instead, the first receiving TAS 210 may generate a virtual INVITE message (vINVITE) in accordance with an embodiment

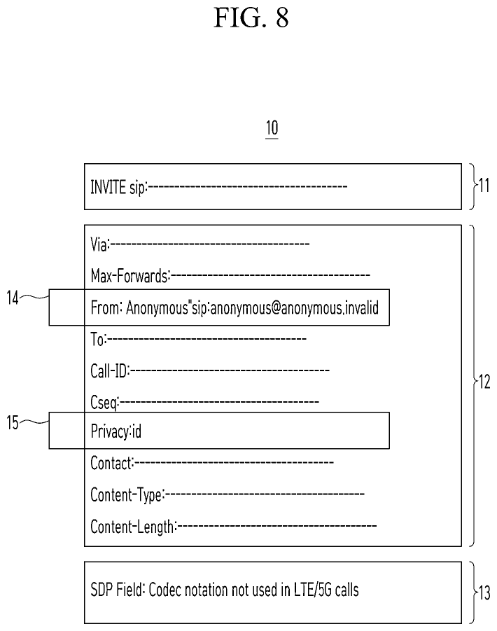

According to the embodiment, the virtual INVITE message (vINVITE) is used to check whether the dual number assigned to the second SIM 120 of the receiving UE 100 is currently engaged in a call (e.g., busy state). The virtual INVITE message (vINVITE) may be generated with the same structure as the typical INVITE message to prevent any disruptions in the call processing within the existing network. The virtual INVITE message will be described in more detail with reference to FIG. 8.

At step S116, the first receiving Telephony Application Server (TAS: 210) sends the virtual INVITE message to the second receiving Telephony Application Server (TAS: 310), which is connected to second SIM 120 assigned with the dual number

At step S117, the second receiving Telephony Application Server (TAS: 310) sends a 100 Trying message to the first receiving Telephony Application Server (TAS: 210).

At this point, if the second SIM 120 is associated with a dual number registered with a service provider different from that associated with the first SIM 110, that is, if the second receiving network 300 belongs to a different service provider, the first receiving Telephony Application Server (TAS: 210) and the second receiving Telephony Application Server (TAS: 310) interwork with each other through the first receiving IBCF 240 and the second receiving IBCF 340.

If the second SIM 120 is a dual number registered with a dual number registered with the same service provider, the first receiving Telephony Application Server (TAS: 210) and the second receiving Telephony Application Server (TAS: 310′) interwork directly without an IBCF.

Since the SIMs installed in the dual SIM UE 100 are usually connected to different networks (e.g., different service provider), the vINVITE message is generally delivered to the second receiving Telephony Application Server (TAS: 310) through the IBCF (240, 340). However, if the user has installed SIMs from the same carrier, the vINVITE message may be sent directly to the dual number's receiving Telephony Application Server (TAS: 310′) without passing through the IBCF.

At step S118, the second receiving Telephony Application Server (TAS: 310) sends a subscriber inquiry request to the second receiving Home Subscriber Server (HSS: 320) to retrieve the network registration information and supplementary service information for the dual number and then receives a response.

At step S119, the second receiving Telephony Application Server (TAS: 310) queries the second receiving Home Subscriber Server (HSS: 320) for the call status of the dual number.

At step S120, the second receiving Home Subscriber Server (HSS: 320, 320′) determines whether the call status of the dual number is in an idle state or a busy state.

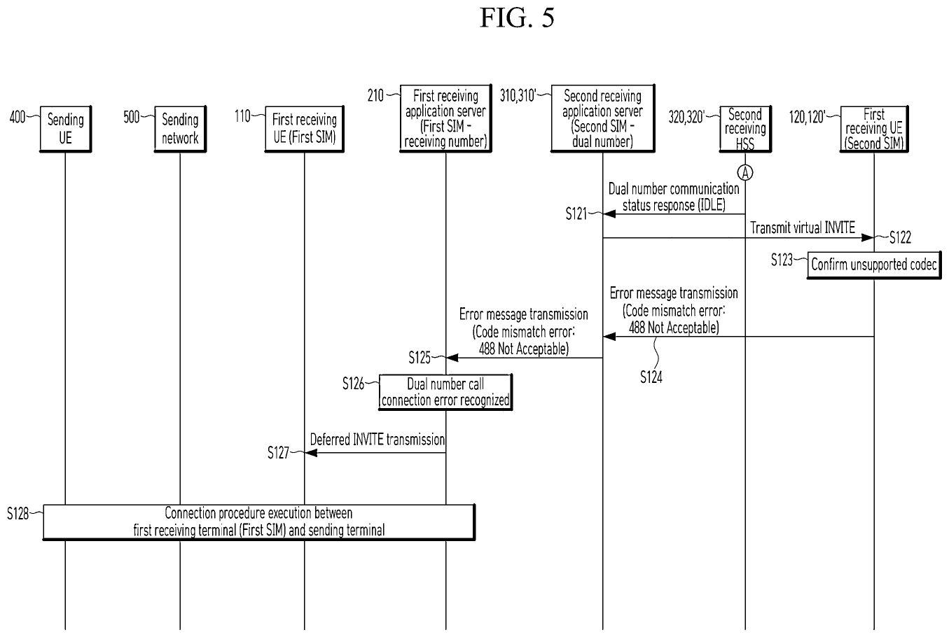

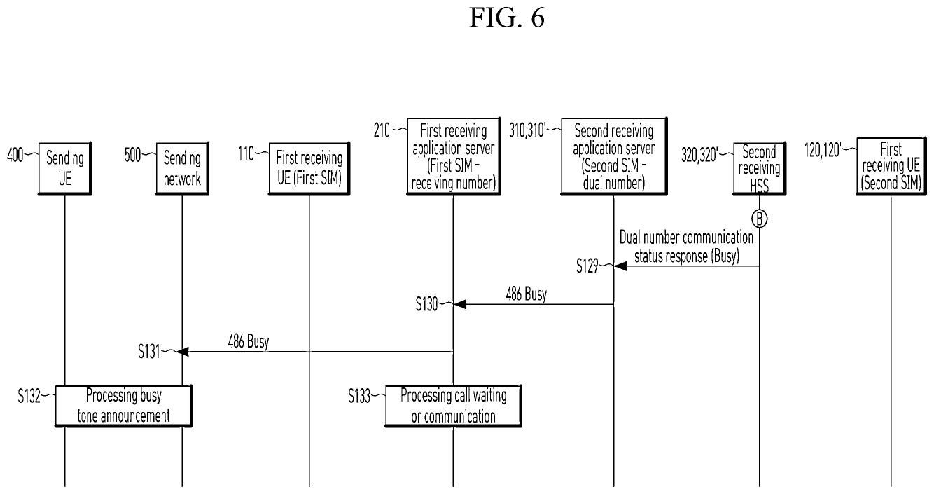

If the call status of the dual number on the second SIM 120 is idle, the second receiving HSS 320 performs the operation described in FIG. 5. If the call status of the dual number on the second SIM 120 is busy, it performs the operation described in FIG. 6.

According to the embodiment described above, at steps S115 and S116, the first receiving Telephony Application Server (TAS: 210) generates and sends a virtual INVITE (vINVITE) message, effectively acting as a virtual receiving application server. This represents a new technique that does not exist in the current IMS network.

The second receiving Telephony Application Server (TAS: 310) receives the virtual INVITE (vINVITE) message and performs typical receiving network operations. At this point, the second receiving Telephony Application Server (TAS: 310) does not know that the message received at step S116 is a virtual INVITE (vINVITE) message. Therefore, there is no need to develop additional functionalities for the dual number's second receiving Telephony Application Server (TAS: 310) to handle the virtual INVITE (vINVITE) message in accordance with an embodiment.

FIG. 5 is a flowchart illustrating the SIP signaling procedure when the call status of the dual number on SECOND SIM of the sending UE is in an idle state, according to an embodiment.

Referring to FIG. 5, if the second receiving HSS 320 determines that the call status of the dual number is idle, the second receiving HSS 320 sends a call status response (IDLE) message to the second receiving Telephony Application Server (TAS: 310) at step S121, indicating that the call status is idle.

Since the second receiving Telephony Application Server (TAS: 310) received a response indicating that the call status of the dual number, that is, the call status of the second SIM 120 of the receiving UE 100, is idle, the second TAS 310 forwards the virtual INVITE (vINVITE) to the second SIM 120 as is at step S122.

The second receiving Telephony Application Server (TAS: 310) does not know that the received virtual INVITE (vINVITE) is not a standard INVITE message and, therefore, follows the standard call handling procedures.

If the current call status of the dual number assigned to the second SIM 120 is idle, the virtual INVITE (vINVITE) message is ultimately delivered to the receiving UE 100. In this case, if there is no special handling of the vINVITE message, the receiving UE 100 will respond with a Ringing code, causing the phone to ring.

To prevent the receiving UE 100 from ringing, the first receiving Telephony Application Server (TAS: 210) intentionally specifies a codec in the message body of the virtual INVITE (vINVITE) message, that is not supported by the current network standards (LTE/5G), when generating the virtual INVITE (vINVITE) in accordance with an embodiment. Such unsupported codec in the message body of the virtual INVITE message deliberately causes a session description protocol (SDP) negotiation failure.

Therefore, the receiving UE 100 identifies the unsupported codec in a session description protocol (SDP) field of the virtual INVITE message at step S123.

At step S124, the receiving UE 100 recognizes this as a codec mismatch error and sends an error message, specifically a 488 Not Acceptable message, to the second receiving Telephony Application Server (TAS: 310).

At step S126, the first receiving Telephony Application Server (TAS: 210) receives the error message (488 Not Acceptable) and recognizes it as a dual number call connection error related to the virtual INVITE message. As a result, it does not perform any further SDP negotiation or re-INVITE actions

At step S127, the first receiving Telephony Application Server (TAS: 210) sends the INVITE message, which was placed on hold at step S111, to the original actual destination number associated with the first SIM 110.

At step S128, the first receiving Telephony Application Server (TAS: 210) proceeds with the normal call connection process involving the receiving UE 110, the sending network 500, and the sending UE 400.

As described in FIG. 3, in the case of the duplicate calls, the first call receiving application server 210 had no way of knowing the current call status of the dual number on the second SIM. However, in accordance with the embodiment, the first call receiving application server 210 may accurately recognize the current call status of the dual number on the second SIM. Therefore, since the first call receiving application server 210 recognizes that the dual number on the second SIM is currently in an idle state, it may determine that it is appropriate to send the INVITE message to the actual destination number.

In addition, according to another embodiment, the first call receiving application server 210 and the second call receiving application server 310 may agree (define) on an indicator that allows them to mutually recognize the virtual INVITE message.

For example, the first call receiving application server 210 may define a new field in the header of the virtual INVITE message for the virtual INVITE indicator, and for the virtual INVITE message related to the call status of the dual number on the second SIM, the virtual INVITE indicator may be specified in this field.

Then, the second call receiving application server 310 may recognize the INVITE message containing the virtual INVITE indicator as a virtual INVITE message and, if the dual number on the second SIM is in an idle state, the second call receiving application server 310 may immediately send an error message, such as a 488 Not Acceptable message, to the first call receiving application server 210 without forwarding the virtual INVITE message to the receiving UE 100.

FIG. 6 is a flowchart illustrating a method for handling duplicate calls when the dual number on the second SIM is in a busy state, according to an embodiment.

Referring to FIG. 6, at step S219, the second call receiving HSS 320 confirms that the dual number on the second SIM is busy and sends the dual number call status response (e.g., busy) to the second call receiving application server 310.

At step S130, when the second call receiving application server 310 confirms that the dual number is in a busy state, the second call receiving application server 310 sends a busy response message (486 Busy) to the first call receiving application server 210.

At step S131, the first call receiving application server 210 sends the busy response message (486 Busy) to the sending network 500.

At step S132, the sending network 500 transmits a message to the sending UE 400, informing that the receiving UE 100 is busy. In other words, although the call was made to the first SIM, a busy message is transmitted because the second SIM is in use.

At step S133, when the first call receiving application server 210 receives the busy response message (486 Busy), the first call receiving application server 210 handles the supplementary services according to the subscription service status of the first SIM 110. The supplementary service includes a call waiting service that notifies incoming call, provide an option to answer or decline, and switches between calls, and a call notification service (e.g., catch call service) that notifies a missed call and provider sender information.

At this time, if the first SIM 110 is subscribed to the call waiting service, the first call receiving application server 210 may handle the call waiting operation first before sending step S131.

In addition, if the first SIM 110 is subscribed to the catch call service, the first call receiving application server 210 may send a text message notifying of the incoming call to the phone number of the first SIM 110.

As such, in the case of the duplicate calls, the first call receiving application server 210 had no way of knowing the current call status of the dual number. However, in accordance with the embodiment, the first call receiving application server 210 may obtain the call status of the dual number. Consequently, even if the actual destination number is in an idle state, if the dual number is busy, the call may be treated as busy, and the catch call operation may be performed as if the actual destination number were busy. This completely resolves the duplicate call of dual SIM UEs described in FIG. 3.

According to the embodiment described above, if the shadow area guidance message is sent from the sending network 500 to the sending UE 400, it is not an error operation caused by the duplicate call issue of the receiving UE 100. In fact, the shadow area guidance message is sent from the sending network 500 because the receiving UE 100 is actually in a shadow area.

FIG. 7 is a flowchart illustrating a method of handing duplicate call when the call status of the destination number is in a busy state, according to one embodiment.

Referring to FIG. 7, at step S113, if the call status of the destination number is determined to be busy, the first call receiving HSS 220 sends a call status response indicating that the destination number is in a busy state to the first call receiving application server 210.

The subsequent operations are similar to the typical busy call handling procedures.

At step S134, the first call receiving application server 210 sends the busy response message (486 Busy) to the sending network 500.

At step S135, the sending network 500 broadcasts a message to the sending UE 400, informing that the receiving UE 100 is busy.

At step S136, when the first call receiving application server 210 receives the busy response message (486 Busy), it handles the catch call service or call waiting service according to the subscription service of the first SIM 110.

At this time, if the first SIM 110 is subscribed to the call waiting service, the first call receiving application server 210 may handle the call waiting operation first before sending step S134.

In addition, if the first SIM 110 is subscribed to a predetermined call service for providing a text message for notification, such as a catch call service, the first call receiving application server 210 may send a text message notifying of the incoming call to the phone number of the first SIM 110.

Hereinafter, the virtual INVITE (vINVITE) message will be described with reference to FIG. 8. The virtual INVITE (vINVITE) message has the same format as a typical INVITE message used in the Session Initiation Protocol (SIP), the description will focus on the newly defined components in the virtual INVITE message.

FIG. 8 is a diagram illustrating a virtual INVITE (vINVITE) message according to an embodiment.

Referring to FIG. 8, the virtual INVITE message 10 includes a Start Line 11, a Header Field 12, and a Message Body Field 13.

Header Field 12 is composed of multiple header fields. In particular, the Header Field 12 includes at least one header field configured to withhold the sender information (e.g., caller ID) from being displayed.

For example, the Header Field 12 includes a From header field 14 and a Privacy header field 15. According to an embodiment, the From header field 14 and Privacy header field 15 are configured as follows.

The From header field 14 is set to “Anonymous” sip: anonymous@anonymous.invalid. In other words, the sender is set as anonymous.

The Privacy header field 15 is configured to “id”. When “id” is included in the Privacy header field 15, a P-Asserted-Identity header in the INVITE message is deleted from the Header Field 12 when transmitting the SIP message to an untrusted domain.

The P-Asserted-Identity header is used between trusted SIP components to identify the user sending the SIP message.

By configuring the From header field 14 as “Anonymous” sip: anonymous@anonymous.invalid and setting the Privacy header field 15 to “id”, it prevents the catch call service from operating on the second call receiving application server 310.

Since the second call receiving application server 310 does not know that the received INVITE message is a virtual INVITE, the second call receiving application server 310 performs standard call handling. If the headers are not configured as described above and if the dual number is subscribed to the catch call service, the catch call service may be activated after the call ends if the dual number is currently busy. The catch call service is a feature that notifies the user of missed calls via text when the line is busy or the device is turned off. Thus, the virtual INVITE message prevents additional services from being triggered.

If the dual number receives the supplementary service including a call waiting service and a call notification service without anyone actually making a call to it, an unusual situation occurs. Therefore, the configuration of the From header field 14 and Privacy header field 15 is a crucial function to prevent this problem.

Additionally, in the Message Body Field 13, the Session Description Protocol (SDP) field is set to include an unsupported codec that is not supported by the communication services (LTE, 5G).

When the dual number of the second SIM 120 is in an idle state, the virtual INVITE (vINVITE) message is eventually delivered to the receiving UE 100. If there is no special handling for the vINVITE message, the receiving UE 100 will respond with a Ringing code, causing the phone to ring.

To prevent this, an unsupported codec, which is not supported by the current network standards (LTE/5G), is deliberately specified to induce an SDP negotiation failure. When the receiving UE 100 detects the unsupported codec in the SDP field of the virtual INVITE message, the receiving UE 100 generates a 488 Not Acceptable message due to the codec mismatch error, rejecting the call.

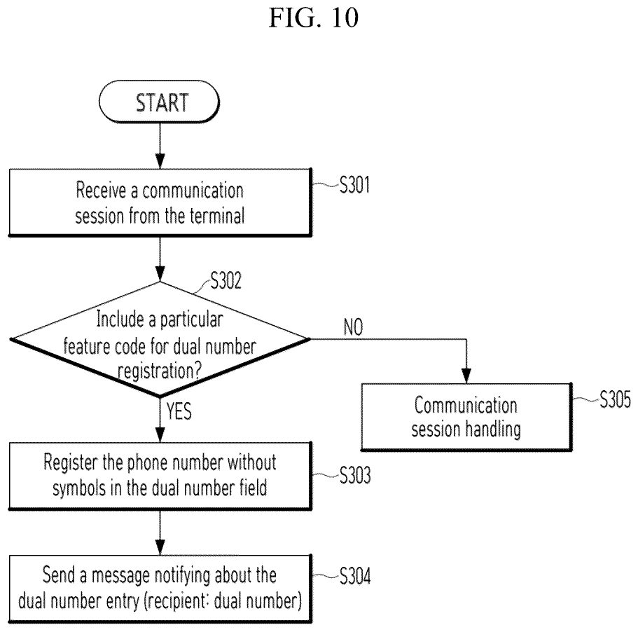

Hereinafter, a method of activating a duplicate call processing service by registering a dual number of a second SIM in accordance with an embodiment will be described with reference to FIG. 9 and FIG. 10. The duplicate call processing service may be a service provided by a telecommunications service provider to a subscriber. Such a duplicate call processing service may be activated by registration of the dual number. For example, when a user registers the dual number, the duplicate call processing service may be activated. Upon the activation, the duplicate call processing method according to the embodiment shown in FIG. 4 to FIG. 7 or FIG. 12 to FIG. 13 are performed.

According to an embodiment, a user may directly register the dual number of the second SIM to the associated communication network. Upon the registration of the dual number, the duplicate call processing service may be activated (e.g., invoked, requested). The dual number may be registered as part of the dual SIM or, if using two separate devices, one device may be registered as a dual number to function similarly to a dual SIM setup.

For example, as explained in FIG. 3, if a user experiences the duplicate calls with a dual SIM UE, they can register for a call waiting service instead of a no-signal handling service. Users can specify their dual number and directly subscribe to the service themselves.

Alternatively, without any specific action from the user, the device can automatically send a message during network registration (device location registration) that includes all the numbers it holds. The telecom provider can then manage the dual number by defining a new field in the subscriber profile.

When the user directly subscribes to additional services offered by the telecom provider, they can do so through the customer service website/app or simply by making a call using a combination of a specific feature code and their dual number. For example, if the user has 010-1234-1234 as their dual number, they can subscribe by dialing “*22#01012341234” and pressing the call button.

Furthermore, from the perspective of the telecom provider, if the registered dual number belongs to another provider, there is no way to verify if the number is genuinely under the user's name.

Therefore, to prevent unauthorized service subscriptions, the embodiment of the present invention may include a procedure where a message is sent to the registered dual number, notifying the service registration and providing instructions on how to cancel or block the service at any time.

Additionally, during device power on/off or registration, all the numbers associated with the dual SIM device can be registered. At this time, the dual SIM device sends the dual number in the REGISTER message header, and the receiving application server updates the subscriber profile with the dual number in the dual number field.

The dual number field can be divided into fields for numbers from the same provider and those from other providers for separate management.

Each telecom provider can define new fields and procedures for services related to dual number registration on the second SIM. For example, for a V Coloring service, which shows a pre-set video to callers until the call is connected, the provider can define a VRTYStatus field in the subscriber profile. The catch call service is managed with fields like MCSStatus, and simultaneous ringing services are managed with fields such as OCSNumber, ForkMode, ForkMNumber, and ForkSNumber.

FIG. 9 illustrates the registration procedure for dual SIM information on a dual SIM device.

Here, the dual SIM device is the receiving UE 100 as previously described. The receiving application server is the first call receiving application server 210, and the receiving HSS is the first call receiving HSS. In FIG. 9, the terms have been changed from “receiving” to “originating” because the dual SIM device initiates the message, but the equipment itself remains the same.

At step S201, the dual SIM device 100 includes the dual number it wants to register, that is, the number of the second SIM 120, in the newly defined dual number field of the network registration (REGISTER) message.

At step S202, the dual SIM device 100 sends the network registration (REGISTER) message, which includes the dual number, to the receiving application server 210.

At step S203, the receiving application server 210 forwards the network registration (REGISTER) message to the receiving HSS 220.

At step S204, the receiving HSS 220 extracts the dual number from the dual number field of the network registration (REGISTER) message and records it in the dual number field of the subscriber profile.

At step S205, the receiving HSS 220 can work with the telecom provider's SMS center to send a message to the dual SIM device 100 (addressed to the dual number) notifying that the dual number has been registered.

FIG. 10 shows a method for registering a dual number of a dual SIM device according to another embodiment.

Here, the dual SIM device is the previously described receiving UE 100. The receiving application server is the first call receiving application server 210, and the receiving HSS is the first call receiving HSS. In FIG. 10, the term is changed from “receiving” to “originating” because the dual SIM device initiates the message, but the equipment remains the same.

The registration procedure in FIG. 10 is described as follows:

At step S301, the first call receiving application server 210 receives a call request (e.g., a dual SIM service registration request) from the dual SIM device 100. The dual SIM service registration request may be tied to a specific number defined for this purpose. For example, it could be a number like *88, and upon receiving this number, the system checks for a specific feature code indicating a dual SIM service registration request.

At step S302, the presence of a specific feature code in the received call request is determined.

If the first call receiving application server 210 determines that the received call request does not contain a specific feature code (S302—NO), it performs general call handling at step S305.

If the first call receiving application server 210 determines that the received call request contains a specific feature code (S302—YES), it forwards the call request with the feature code to the receiving HSS At step S303.

At step S303, the receiving HSS 220 extracts the phone number from the call request, excluding the special feature code, and registers it in the dual number field of the subscriber profile.

At step S304, the receiving HSS 220 can work with the telecom provider's SMS center to send a message to the dual SIM device 100 (addressed to the dual number) notifying that the dual number has been registered.

As described above, in the embodiments shown in FIG. 1 to FIG. 10, the first receiving application server 210 sends a virtual INVITE message to the second receiving application server 310 to check the call status of the dual number regardless of whether the telecommunications service provider associated with the second SIM's dual number is the same as or different from the one associated with the first SIM.

In other words, during the subscriber information registration phase in the HSS, only the dual number field is defined, and the dual number of the second SIM is recorded without distinguishing whether the telecommunications service provider associated with the second SIM is the same as or different from the service provider of the first SIM. The phone number of the second SIM is extracted from the network registration message.

Thus, in the embodiments shown in FIG. 1 to FIG. 10, if the dual number is included in the 200 OK message, it is recognized as a dual number subscriber without distinguishing between the company's network and a third-party network. The procedure involves using a virtual INVITE message to check the call status of the dual number.

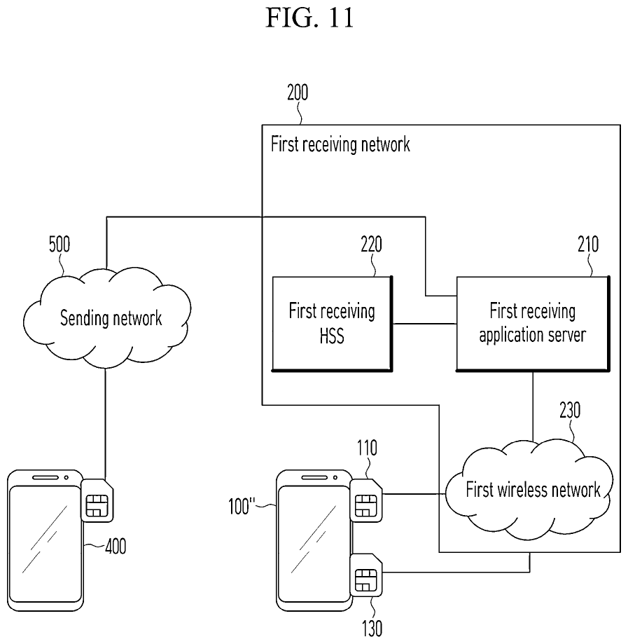

In another embodiment, if the telecommunications service provider associated with the second SIM (e.g., dual number) is the same as that associated with the first SIM, the call status of the dual number may be checked through the HSS without sending a virtual INVITE message. This embodiment will be described with reference to FIG. 11 to FIG. 13.

In another embodiment, during the HSS subscriber information registration phase, both a same-provider dual number field and a different-provider dual number field may be defined. The same-provider dual number field records the dual number of the second SIM if both SIMs are connected to the same telecommunications service provider as the first SIM. Conversely, the different-provider dual number field records the dual number of the second SIM if it is connected to a different telecommunications service provider. If the second SIM's telecommunications service provider differs from that of the first SIM, the phone number is extracted from the network registration message and registered in the different-provider dual number field. If the second SIM uses the same provider as the first SIM, it is automatically registered in the same-provider dual number field.

FIG. 11 shows a network structure for handling duplicate calls in a dual-SIM UE according to another embodiment.

Referring to FIG. 11, the explanations of parts similar to those in the network structures described in FIGS. 1 and 2 are omitted, and only the different configurations will be described.

The receiving UE 100″ includes a first SIM 110 and a second SIM 130. The first SIM 110 and the second SIM 120 both use the telecommunications service of the same provider. That is, since the second SIM of the receiving UE 100″ is a subscriber of the same telecommunications service provider, it is connected to the same receiving network. In practice, even if the networks are distinct, they effectively share the HSS storing the subscriber information of both the first SIM 110 and the second SIM 130, so the call status may be confirmed without sending a virtual INVITE.

In other words, the first SIM 110 and the second SIM 130 use the first receiving network 200 operated by the same telecommunications provider. More specifically, the first SIM 110 and the second SIM 130 are connected to the first receiving application server 210 and the first HSS 220 through the first receiving wireless communication system 230.

Thus, the first receiving application server 210 may operate differently depending on whether the dual number is subscribed to the same telecommunications provider or a different one.

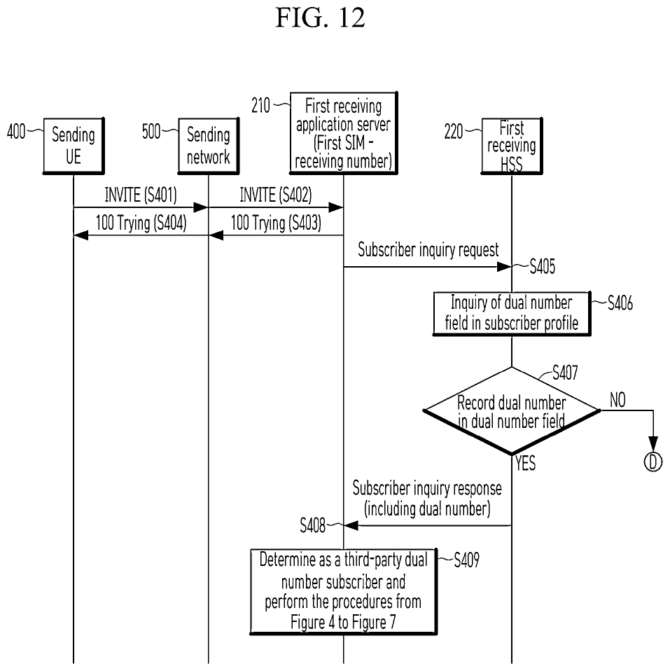

FIG. 12 is a flowchart illustrating a method for processing duplicate calls in accordance with another embodiment. That is, FIG. 12 shows a SIP signaling procedure for a dual-SIM subscriber UE according to another embodiment.

Referring to FIG. 12, at step S401, the sending UE 400 sends an INVITE message. At step S402, the sending network 500 receives the INVITE message and forwards the INVITE message to the first receiving application server 210. At step S403, the first receiving application server 210, connected to the first SIM 110, sends a 100 Trying message to the sending network 500 in response.

At step S404, the sending network 500 sends the 100 Trying message to the sending UE 400. At step S405, the first receiving application server 210 sends a subscriber inquiry request to the first receiving HSS 220 to query the registration information and supplementary service information of the receiving network. At step S406, the first receiving HSS 220 queries the different-provider dual number field in the subscriber profile based on a recipient number included in the subscriber inquiry request. At step S407, the first receiving HSS 220 determines whether the dual number is recorded in the different-provider dual number field.

If the dual number is recorded in the different-provider dual number field (S407—YES), the first destination HSS 220 extracts the dual number from the different-provider dual number field, identifies that the extracted dual number is associated with a different provider, and sends a subscriber inquiry response, including the extracted dual number, to the first receiving application server 210 at step S408.

At step S409, if the first receiving application server 210 receives a subscriber inquiry response containing a different-provider dual number from the first destination HSS 220, it recognizes the receiving UE 100″ as a dual-number subscriber and simultaneously as a different-provider dual number subscriber, and it performs the procedure described in FIG. 4 to FIG. 7.

In this step, a virtual INVITE message is generated to check the call status of the dual number, and based on this, the operation to decide whether to process the INVITE message received at step S402 is performed.

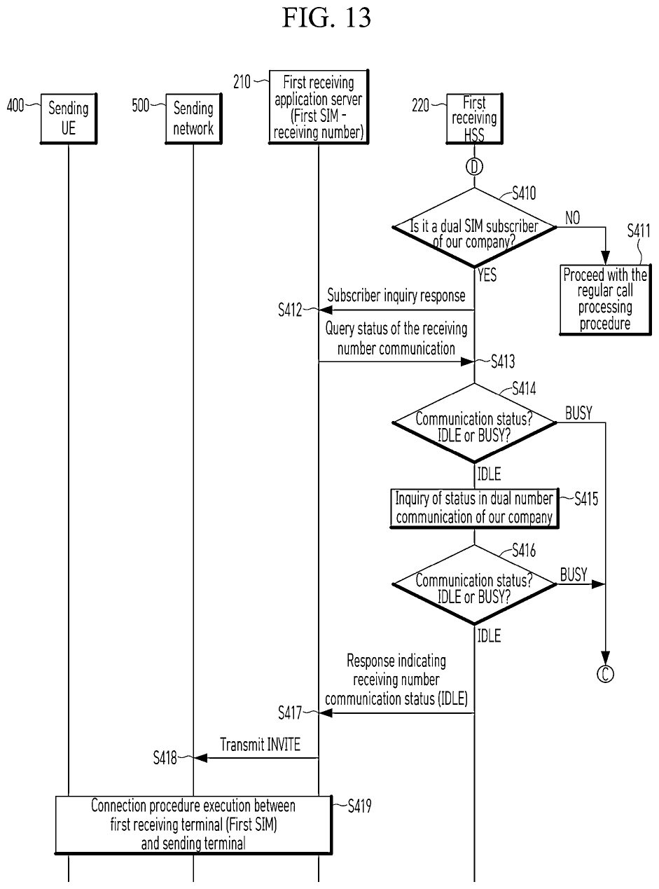

Conversely, if the dual number is not recorded in the different-provider dual number field (S407—NO), the procedure described in FIG. 13 is performed.

FIG. 13 is a flowchart illustrating the method of processing duplicate calls when the dual SIMs of the receiving UE are determined to be subscribed to the same telecommunications provider, according to another embodiment.

Referring to FIG. 13, if the first receiving HSS 220 determines that the dual number is not recorded in the different-provider dual number field (S407—NO), the first receiving HSS checks whether the dual number is subscribed to the same service provider of the first SIM at step S410. This may be verified by checking if the dual number is registered in the same-provider dual number field in the HSS or separately in the subscriber profile.

If the dual SIM is not subscribed to the same provider (S410—NO), a typical call handling process is performed at step S411. Since the typical call handling process is well-known, detailed descriptions thereof are omitted herein.

If the dual SIM is subscribed to the same provider (S410—YES), a subscriber inquiry response is sent to the first receiving application server 210 without including the dual number in the dual number field at step S412.

At step S413, the first receiving application server 210 sends a call status inquiry of the recipient number (e.g., called number) to the first receiving HSS 220.

At step S414, the first receiving HSS 220 checks the call status of the recipient number to determine if it is idle or busy.

If the call status of the called number (e.g., recipient number) is determined to be idle (S414—IDLE), the first receiving HSS 220 checks the call status of the same-provider dual number at step S415.

At step S416, the first receiving HSS 220 determines if the call status of the same-provider dual number is idle or busy. If the status of the same-provider dual number is idle (S416—NO), an idle status response is sent at step S417.

At step S418, the first receiving application server 210 forwards the INVITE message received in step S402 to the sending network 500.

At step S419, a call connection procedure between the receiving UE (first SIM) 100 and the originating UE 400 is carried out.

Conversely, if the call status of the called number is busy at step S414 or the call status of the same-provider dual number is busy, the operation proceeds as described in FIG. 7. In this case, the called number is treated as busy, and the originating network sends a busy tone announcement. The first receiving application server 210 processes call waiting or catch call features for the receiving UE (first SIM) 100, depending on the subscription.

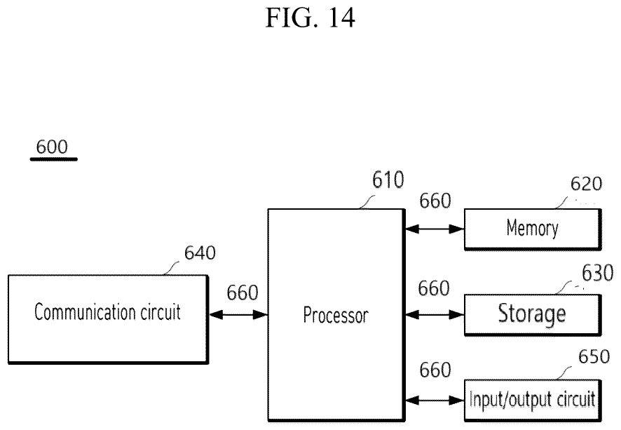

FIG. 14 is a block diagram illustrating the hardware configuration of a computing device according to one embodiment.

The UEs 100, 400, the destination application servers 210, 310, 310′, 310″, the destination HSSs 220, 320, 320′, and the destination IBCFs 240, 340 described in FIGS. 1 to 13 may be computing devices 600 operating under at least one processor.

The computing device 600 may include one or more processors 610, memory 620 that loads programs executed by the processor 610, storage 630 for storing programs and various data, a communication interface 640, an input/output circuit 650, and a bus 660 connecting these components. Additionally, the computing device 600 may include various other components.

When loaded into the memory 620, the program may include instructions that enable the processor 610 to perform the methods/operations according to various embodiments of the present disclosure. In other words, by executing these instructions, the processor 610 can carry out the methods/operations according to various embodiments of the present disclosure. The instructions refer to a set of computer-readable commands grouped by functionality, forming part of a computer program and executed by the processor.

The processor 610 controls the overall operations of each component of the computing device 600. The processor 610 may be configured to include at least one of a CPU (Central Processing Unit), MPU (Micro Processor Unit), MCU (Micro Controller Unit), GPU (Graphic Processing Unit), or any type of processor well-known in the technical field of the present disclosure. Additionally, the processor 610 can perform computations for at least one application or program to execute the methods/operations according to various embodiments of the present disclosure.

The memory 620 stores various data, commands, and/or information. To execute the methods/operations according to various embodiments of the present disclosure, the memory 620 may load one or more programs from the storage 630. The memory 620 may be implemented as volatile memory, such as RAM, but the technical scope of the present disclosure is not limited to this.

The storage 630 can non-temporarily store programs. The storage 630 may include non-volatile memory such as ROM (Read Only Memory), EPROM (Erasable Programmable ROM), EEPROM (Electrically Erasable Programmable ROM), flash memory, hard disks, removable disks, or any type of computer-readable recording medium well-known in the technical field of the present disclosure.

For example, the storage 630 may include at least one of an internal memory and an external memory according to embodiments. For example, memory 130 may be a flash memory, hard disk, multimedia card micro memory, SD or XD memory, Random Access Memory (RAM), Static Random-Access Memory (SRAM), Read-Only Memory (ROM), Programmable Read-Only Memory (PROM), Electrically Erasable Programmable Read-Only Memory (EEPROM), magnetic memory, magnetic disk, or optical disk, a SD card, a USB memory, but is not limited thereto.

The communication interface 640 supports the wired or wireless communication of the computing device 600. For this purpose, the communication interface 640 may be configured to include communication modules well-known in the technical field of the present disclosure.

For example, communication interface 640 may include at least one circuitry module (or at least one circuit) for communicating with other entities through core network 200 or directly communication with second device 400. Herein, the communication network may include a variety of communication networks such as a wireless communication network and a wired communication network. For example, the communication network may include a wideband code division multiple access (WCDMA) network, a microwave access (WiMAX) network, a wireless fidelity (WiFi) network, a long term revolution (LTE) network, x digital subscriber line (xDSL) network, a hybrid fiber-coaxial (HFC) network, a satellite network, a global system for mobile communication (GSM) edge radio access network (GERAN), a universal terrestrial radio access network (UTRAN), an evolved universal terrestrial radio access network (E-UTRAN), a wireless local area network (W-LAN), a public switched telephone network (PSTN), an integrated services for digital network (ISDN), an international mobile telecommunications (IMT)-2000 network, a wired area network (WAN), a local area network (LAN), a metropolitan area network (MAN), a cable television (CATV), third generation partnership project core networks (3GPP-CNs), an European telecommunications standards institute telecommunication & internet converged service & protocols for advanced networks core network (ETSI TISPAN CN), a 3GPP2 CN, a machine to machine (M2M) network, a broadcast network, a radio frequency identification (RFID) network, a near field communication (NFC) network, a ultra-wideband (UWB) network, a Bluetooth communication network, but the present disclosure is not limited thereto. In at least one embodiment, communication circuit 1300 may include at least one of a wireless communication circuit and a wired communication circuit. Herein, the wireless communication circuit and wired communication may be separately or integrally configured.

Input/output circuit 650 may include an input circuit as a user interface for receiving input from a user. For example, the input circuit may include any of a keypad, a dome switch, a touch pad, a jog wheel, and a jog switch, but is not limited thereto. Further, the input circuit may include several hardware key buttons. The hardware key buttons may include a hold key and a volume control button. Input/output circuit 650 may include an output circuit that includes a display panel and a circuit for controlling the display panel for visually outputting information processed by the processing circuit 610.

The bus 660 provides communication functionality among the components of the computing device 600. The bus 660 may be implemented in various forms, such as an Address Bus, Data Bus, and Control Bus.

In accordance with an embodiment display of output circuit 150 may display a graphs user interface that shows various information on second devices 400 and corresponding status of having the bidirectional communication service. The graphic user interface may be formed by executing a bidirectional communication service app installed in UE 100. Display of output circuit 150 may display i) second devices 400 currently connected to UE 100 but not yet setting up for the bidirectional communication service, ii) second devices 400 being connected to UE and communicating with other devices 500 through the bidirectional communication service, and iii) a current status of corresponding second device, such as a completion of bidirectional communication service or release from bidirectional communication service.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present disclosure can be embodied in the form of methods and apparatuses for practicing those methods. The present disclosure can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present disclosure can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present disclosure can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certaAt steps may be omitted or combined, in methods consistent with various embodiments of the present invention.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

No claim element herein is to be construed under the provisions of 35 U.S.C. § 112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for processing duplicate calls by a first receiving application server, the method comprising:
receiving an INVITE message sent from a sending user equipment (UE) through a sending network;
verifying whether a receiving UE is a dual subscriber identification module (SIM) subscriber by querying subscriber information based on a recipient number in the INVITE message;
in an event that the receiving UE is determined as a dual-SIM subscriber, identifying the recipient number as a first number associated with a first SIM, withholding the INVITE message from being sent to the receiving UE, sending a virtual INVITE message to a second receiving application server connected to a second SIM of the receiving UE;
receiving, from the second receiving application server, a response message including a call status of the second SIM: and
determining whether to establish a call connection between the first SIM and the sending UE, based on the call status of the second SIM included in the response message.

2. The method of claim 1, wherein the determining whether to establish comprises:
in an event that the call status of the second SIM is a busy status, transmitting a response message to the sending network including that the first SIM is in a busy status.

3. The method of claim 1, further comprising:
providing a supplementary service based on subscription status of the first SIM,
wherein the supplementary service includes a call waiting service that notifies incoming call, provide an option to answer or decline, and switches between calls, and a call notification service that notifies a missed call and provides sender information.

4. The method of claim 1, wherein the determining whether to establish comprises:
in an event that the response message is a call connection error message with the second SIM, determining the call status of the second SIM as idle, forwarding the INVITE message received from the sending network to the first SIM, and proceeding with a call setup process between the sending UE and the first SIM.

5. The method of claim 4, wherein the call connection error message is caused by a codec mismatch error.

6. The method of claim 5, wherein the virtual INVITE message include a session description protocol (SDP) field in a message body, configured with an unsupported codec, which is not supported by an associated call service.

7. The method of claim 1, wherein the virtual INVITE message includes at least one header field configured not to inform sender's information.

8. The method of claim 1, wherein the sending a virtual INVITE message to a second receiving application server comprises:
in an event that a dual number field in a subscriber query response from a first subscriber server contains a dual number, sending the virtual INVITE message.

9. The method of claim 1, wherein the sending a virtual INVITE message to a second receiving application server comprises:
sending the virtual INVITE message in an event that the call status of the first SIM is idle.

10. The method of claim 1, wherein:
the virtual INVITE message includes an indicator that indicates the virtual INVITE message is a virtual message intended for verifying a call status of the dual number, and
the second receiving application server perform operations including:
checking the call status of the dual number in an event that the indicator included in the virtual INVITE;
not forwarding the virtual INVITE message to the second SIM associated with the dual number in an event that the status is determined as idle; and
responding to the first receiving application server with an error message.

11. A method of a first subscriber server for processing duplicate calls, the method comprising:
receiving a subscriber query request from a first application server that receives an INVITE message from a sending user equipment (UE) to a first subscriber identification module (SIM) through a sending network;
verifying whether a subscriber associated with a recipient number assigned to the first SIM, included in the subscriber query request, is a dual-SIM subscriber;
sending a subscriber query response, including the dual number assigned to a second SIM, to the first receiving application server to enable checking the call status of the second SIM.

12. The method of claim 11, wherein the verifying comprises:
determining whether the dual number is stored in a dual number field of a scriber profile, which is defined to store the dual number.

13. The method of claim 11, wherein:
the verifying comprises:
checking whether the dual number is stored in a second dual number field, where the second dual number field is allocated for a dual number subscriber of a second service provider which is different from a first service provider associated with the first SIM;
after the verifying, in an event that the dual number is not stored in the second dual number field, checking whether the dual number subscriber is a subscriber of the first service provider associated with the first SIM; and
in an event that the dual number subscriber is the subscriber of the first service provider, upon receiving a call status inquiry for the recipient number from the first receiving application server, checking the call status of the dual number if the call status of the recipient number is idle, sending a response message to the first receiving application indicating that the recipient number is busy if the call status of the dual number is confirmed as busy.

14. The method of claim 12, further comprising, prior to the receiving a subscriber query request from a first application server:
extracting the dual number from a dual number field of a REGISTER message received from a user equipment; and
including the extracted dual number in the dual number field of the subscriber profile.

15. The method of claim 12, further comprising, prior to the receiving a subscriber query request from a first application server:
receiving a call setup request from the UE that includes a predetermined feature code;
recording the dual number extracted from the call setup request in the dual number field of the subscriber profile.

16. An application server comprising:
a memory configured to store at least one command; and
a processor configured to execute the stored at least one commands,
wherein the processor perform operations including:
verifying whether a receiving UE is a dual subscriber identification module (SIM) subscriber by querying subscriber information based on a recipient's number in an INVITE message received from a sending UE through a sending network;
in an event that the receiving UE is determined as a dual-SIM subscriber, identifying the recipient's number as a first number associated with a first SIM, withholding the INVITE message from being sent to the receiving UE, sending a virtual INVITE message to a second receiving application server connected to a second SIM of the receiving UE;
receiving, from the second receiving application server, a response message including a call status of the second SIM: and
determining whether to establish a call connection between the first SIM and the sending UE, based on the call status of the second SIM included in the response message.

17. The application server of claim 16, wherein the processor performs operations includes:
in an event that the call status of the second SIM is a busy status, transmitting a response message to the sending network including that the first SIM is in a busy status.

18. The application server of claim 16, wherein the processor performs operations further includes:
providing a supplementary service based on subscription status of the first SIM,
wherein the supplementary service includes a call waiting service that notifies incoming call, provide an option to answer or decline, and switches between calls, and a call notification service that notifies a missed call and provides sender information.

19. The application server of claim 16, wherein the processor performs operations further includes:
in an event that the response message is a call connection error message with the second SIM, determining the call status of the second SIM as idle, forwarding the INVITE message received from the sending network to the first SIM, and proceeding with a call setup process between the sending UE and the first SIM.

20. The application server of claim 16, wherein the processor performs operations further includes:
the virtual INVITE message includes an indicator that indicates the virtual INVITE message is a virtual message intended for verifying a call status of the dual number, and
the second receiving application server perform operations including:
checking the call status of the dual number in an event that the indicator included in the virtual INVITE;
not forwarding the virtual INVITE message to the second SIM associated with the dual number in an event that the status is determined as idle; and
responding to the first receiving application server with an error message.
